(19) United States
(12) Patent Application Publication
(10) Pub. No.: US 2002/0192453 A1
(43) Pub. Date: Dec. 19, 2002

(54) Composite material having a high thermal conductivity and method for manufacturing the composite material

(75) Inventors: Kazuhisa Shobu, Tosu (JP); Michiru Sakamoto, Tosu (JP); Tatsuo Tabaru, Tosu (JP); Hisatoshi Hirai, Tosu (JP); Akira Kitahara, Tosu (JP); Tomio Sato, Tosu (JP); Isamu Yamashita, Tosu (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Nat'l Inst. of Advanced Ind. Science and Tech., Tokyo (JP)

(21) Appl. No.: 10/100,925

(22) Filed: Mar. 20, 2002

(30) Foreign Application Priority Data
Jun. 15, 2001 (JP) 2001-180968
Jan. 22, 2002 (JP) 2002-013174

(51) Int. Cl. B32B 3/00

(52) U.S. Cl. 428/312.6; 428/307.7; 428/319.1

(57) ABSTRACT

A highly thermally conductive composite material is characterized in that it contains 20-75 Vol % of SiC, with the balance being Cu, and further contains a reaction preventive layer interposed on the interface between SiC and Cu for preventing a reaction between the two substances. Specifically, the reaction preventive layer is a thin film having a thickness of 0.01-10 microns, consisting of carbon or a carbide of at least one element selected from the group consisting of Cr, Nb, Ta and W. In particular, the composite material has a thermal expansion coefficient of 4.5-10×10⁻⁶/K and a thermal conductivity of 200 W/mK or higher.

### TECHNICAL FIELD OF THE INVENTION

The present invention relates to a SiC—Cu composite material having a low thermal expansion coefficient and a high thermal conductivity, which is most suitable for use as a heat dissipation material such as a heat sink material or a package material in an electronic apparatus or in a semiconductor device. Further, this invention also relates to a method for manufacturing the composite material.

### DESCRIPTION OF THE RELATED ART

Due to an increasingly high level integration and an increasingly high speed operation of various semiconductor devices, an amount of heat generated from semiconductor devices has become larger than before. Since an increased temperature in semiconductor devices will often cause a wrong operation as well as an operation failure, research workers have long been engaged in their research activity in order to develop an improved heat dissipation technique by producing various improved materials having a high thermal conductivity. However, in recent years, there has been an increasingly high demand for various improved heat dissipation materials. For example, there has been a demand for developing an entirely new material having a thermal conductivity which is higher than 250 W/mK.

On the other hand, since the above-described heat dissipation material is used in a state in which it is combined with other devices, such a material is required to have not only a high thermal conductivity, but also an appropriate thermal expansion coefficient which is in the same level as that of an associated semiconductor device, so that the combined two elements can be prevented from being broken apart on their interface, a phenomenon often caused due to a thermal expansion. In particular, since silicon and GaAs, each of which is often used to form a semiconductor device, have thermal expansion coefficients of 4.2×10⁻⁶/K and 6.5×10⁻⁶/K, some package materials for use in connection with these semiconductor devices are also required to have the same level thermal expansion coefficients.

Conventionally, a series of W—Cu composite materials are often used in certain portions of an electronic device which are required to have a low thermal expansion coefficient and a high thermal conductivity. In fact, each of these composite materials has a high thermal conductivity, while W has a low thermal expansion coefficient (4.5×10⁻⁶/K). Further, since the two components forming the composite materials have a low reactivity or a low solid solubility with each other, if a composite material has a composition whose W content is high, such a composite material will have a low thermal expansion coefficient and a high thermal conductivity. However, since the thermal conductivity is not higher than 200 W/mK, it is impossible to sufficiently meet the above-described requirements with regard to the recently demanded heat dissipation materials.

On the other hand, in recent years, there has appeared a carbon fiber-Cu composite material which has drawn a considerable attention in industry, since it can be used as a material having a high thermal conductivity. In particular, a graphitized high elastic carbon fiber is found to have an extremely high thermal conductivity in its fiber direction, even higher than 1000 W/mK. Further, such kind of carbon fiber has an extremely low thermal expansion coefficient in its fiber direction. However, a problem associated with the carbon fiber is that its thermal conductivity in its lateral direction is extremely low, and its thermal expansion coefficient in the same lateral direction is extremely large. As a result, a carbon fiber-Cu composite material formed by using such a carbon fiber is anisotropic in its various properties. For example, when a composite material is used to form a heat sink on a thin plate, such a heat sink is usually required to have a high thermal conductivity in its thickness direction and a low thermal expansion in its lateral direction. However, since the above-described carbon fiber has a high thermal conductivity and a low thermal expansion only in its fiber direction, it is required that the carbon fiber be woven into a three-dimensional fabric material. At this time, since a multi-dimensionally woven carbon fiber material is porous in its structure, if Cu is press-infiltrated into such a carbon fiber material at a temperature equal to or higher than its melting point (the melting point of Cu), it is possible to obtain a carbon fiber-Cu composite material having a high density. In fact, there has been recently reported that it is possible to obtain an improved composite material isotropically having a thermal conductivity near 300 W/mK and a thermal expansion coefficient which is as low as 7×10⁻⁶/K. However, a problem is that such a composite material is extremely high in its manufacturing cost.

On the other hand, among various composite materials which have been put into practical use in recent years, there is a SiC—Al composite material (for example, Japanese Unexamined Patent Application Publication No. 02-236244 and Japanese Unexamined Patent Application Publication No. 10-231175). In fact, such a composite material is characterized in that it has a low density and is low in its manufacturing cost. The same composite material is also well-known for its relatively high thermal conductivity and its relatively low thermal expansion coefficient. However, since each of the two essential components SiC and Al has a thermal conductivity which is not higher than 250 W/mK, it is in fact not easy to obtain a composite material having a thermal conductivity which is equal to or higher than 200 W/mK.

In view of the above, there has been suggested a further improved composite material formed by combining SiC with Cu which has a high thermal conductivity (for example, Japanese Unexamined Patent Application Publication No. 08-279569). However, one problem associated with this composite material is that SiC will react with Cu during the manufacturing process, resulting in a silicide of Cu as well as a carbon, hence considerably reducing its thermal conductivity In order to solve this problem, U.S. Pat. No. 6,110,577 has suggested a method which requires that a temperature necessary for the manufacturing process be controlled as low as possible and that a combining process for producing a composite material be completed within a shortened time period. In this way, it is possible to manufacture an improved SiC—Cu composite material, with an undesired reaction being reduced between SiC and Cu. On the other hand, although small in its amount, if Si is solid-dissolved into Cu, the thermal conductivity of a resulting composite material will be greatly reduced. As a result, it is impossible for the resulting composite material to ensure a high thermal conductivity originally possessed by one of its essential components.

As may be understood from the above discussion, none of the aforementioned conventional composite materials can be used to provide, at a low cost, a low thermal expansion coefficient and a high thermal conductivity, both of which are needed for ensuring a high speed operation and a large scale size demanded by industry in manufacturing a semiconductor device or an electronic apparatus. As a result, the industry is still faced with a task for providing an improved new composite material.

### SUMMARY OF THE INVENTION

This invention has been accomplished in order to fulfill the above-mentioned requirement and it is an object of the invention to provide, at a low cost, an improved composite material having a high thermal conductivity and a low thermal expansion coefficient, suitable for use as a heat dissipation material in an electronic apparatus or a semiconductor device.

In more detail, an object of the present invention is to provide a composite material having a low thermal expansion coefficient (4.5-10×10⁻⁶/K) and a high thermal conductivity (≧200 W/mK), which is suitable for use with an existing package material.

Another object of the present invention is to solve the above-discussed problem existing in the above-mentioned SiC—Cu composite material, and to provide at a low cost an improved composite material having a low thermal expansion coefficient and a high thermal conductivity.

As a result, the inventors of the present invention, after an extensive research on how to solve the above-discussed problem existing in the above-mentioned SiC—Cu composite material, found out the following technical solutions, thereby accomplishing the present invention based on these foundings.

Namely, since the thermal conductivity of a composite material depends greatly on an amount of scattering factors, in order to obtain a high thermal conductivity, not only is it necessary to inhibit a reaction between SiC and Cu, but also to have each phase maintained at an extremely high purity. For this reason, it is necessary to provide an appropriate film to prevent the reaction between SiC and Cu during a manufacturing process.

As a result, it was found that it is effective for a composite material to form a structure having a thin reaction preventive layer at the interface between SiC and Cu, and that a substance forming the reaction preventive layer should be an element or a compound which does not react with either SiC or Cu, and which will not substantially solid-dissolve into the two phases. Consequently, it was found that such a reaction preventive layer can be formed by carbon or a carbide of at least one element selected from the group consisting of Cr, Nb, Ta and W. On the other hand, although Re is also effective for forming the reaction preventive layer, it has a problem of being high in price.

As to thermal expansion coefficient, it is possible to obtain a desired thermal expansion coefficient (4.5 to 10×10⁻⁶/K) by forming a strong skeleton structure of SiC.

The highly thermally conductive composite material of the present invention, obtained in accordance with the above-discussed findings, is characterized in that it comprises 20-75 Vol % of SiC, with the balance being Cu, and contains a reaction preventive layer interposed on the interface between SiC and Cu for preventing a reaction between the two substances.

According to the present invention, such a reaction preventive layer may be formed by a thin film having a thickness of 0.01-10 microns, consisting of carbon or a carbide of at least one element selected from the group consisting of Cr, Nb, Ta and W.

Preferably, the composite material of the present invention has a thermal expansion coefficient of 4.5-10×10⁻⁶/K, and a thermal conductivity of at least 200 W/mK.

According to a concrete embodiment of the present invention, SiC is at first formed into a porous preform having a skeleton structure. Then, the surface of the porous preform is coated with the above-described reaction preventive layer, followed by an infiltration treatment in which Cu is infiltrated into the preform.

According to another concrete embodiment of the present invention, the composite material may be in the form of a sintered body obtained by press-sintering an amount of mixed powder containing a SiC powder material and a Cu powder, with the SiC powder material being in advance coated by the reaction preventive layer.

In order to obtain the above-described composite material, according to the present invention, there is also provided a method for manufacturing a composite material having a high thermal conductivity. This method is characterized in that both the internal and external surfaces of the porous SiC preform having the aforementioned skeleton structure are coated with a reaction preventive layer consisting of an element or a compound which does not react with either SiC or Cu, nor will it substantially solid-dissolve into the two phases. Then, Cu is press-infiltrated into the preform.

Furthermore, a second method of the present invention is characterized in that the surface of the SiC powder material is coated with a reaction preventive layer consisting of an element or a compound which does not react with either SiC or Cu, nor will it substantially solid-dissolve into the two phases. Then, the SiC powder material is mixed with Cu powder so as to obtain a powder mixture which is in turn press-sintered at a temperature of 400-1000° C.

According to each of the above methods of the present invention, the reaction preventive layer is a thin film consisting of carbon or a carbide of at least one element selected from the group consisting of Cr, Nb, Ta and W. In fact, such a thin film is formed by coating and has a thickness of 0.01-10 microns.

Further, the above mixed powder may be formed by mixing 20-75 vol % of SiC powder material (coated with a reaction preventive layer) with the balance of Cu powder.

In this way, with the use of the composite material having a high thermal conductivity and the above-described structure, and with the use of the method for manufacturing the composite material, it has become possible to provide, at a low cost, an improved composite material having a low thermal expansion coefficient (4.5-10×10⁻⁶/K) and a high thermal conductivity (≧200 W/mK) thereby rendering the composite material suitable for use as a heat dissipation material in an electronic apparatus or in a semiconductor device.

Therefore, the composite material of the present invention obtained in the above-described manner has a low thermal expansion coefficient and a high thermal conductivity, and can be manufactured at a low cost. Thus, such a composite material can be most suitably used as a heat sink material as well as a package material in an electronic apparatus or in a semiconductor device.

### DESCRIPTION OF EXAMPLES

The highly thermally conductive SiC—Cu composite material formed according to the present invention contains 20-75 vol % of SiC and the balance of Cu, as well as a reaction preventive layer interposed on an interface between SiC and Cu to prevent an undesired reaction between the two substances. Although the composite material of the present invention can be manufactured in various methods, a first composite material is manufactured through a process including the preparation of the SiC preform, the formation of the reaction preventive layer by coating, followd by the press-infiltration of Cu.

In fact, the above-described SiC preform may be obtained by using a commercially available SiC raw material powder having a high purity, by means of a molding process such as a molding process using a metal mold (which is a commonly used process). Alternatively, the SiC preform may be obtained by using a material presintered at a temperature of 2000° C. or lower, thereby effecting a sintering solidification to some extent or removing silica from the surface of the preform. However, in order to ensure a high thermal conductivity, it is preferable to obtain a sort of preform consisting of SiC having a high purity and a good crystallinity. In fact, such type of SiC preform may be prepared in a process called re-crystallization in which a commercially available raw material powder is used to form molded product which is then kept at a temperature of 2200° C. or higher. At this time, if a powder mixture is used which contains an amount of coarse SiC powder having a particle size of 40 microns or larger as well as an amount of fine SiC powder having a particle size of 5 microns or smaller, since the fine powder will sublimate and re-crystallize on the coarse powder, it is possible to obtain a continuously formed strong SiC skeleton structure having a relatively coarse porous structure suitable for receiving a Cu press-infiltration treatment and having a low thermal expansion coefficient.

As another preferred method for preparing the preform is a reaction sintering process in which a mixed powder containing a high purity Si and a high purity C (in the same moles) is heated at a temperature of 1400° C. or higher, thereby forming the desired SiC. At this time, as a carbon source, it is preferable to use a high purity carbon powder, as well as a phenol resin or a pitch (all capable of producing the desired carbon upon heat treatment). This is because these carbon sources are effective for obtaining a preform having an excellent moldability and a high density. Moreover, as a carbon source it is also possible to use a carbon fiber. In fact, using a carbon fiber as a carbon source makes it possible to obtain an excellent preform consisting of SiC having a continuously connected internal structure.

Although a relative density of a preform depends on the skeleton structure of SiC, if it is desired to obtain a low thermal expansion coefficient and a high thermal conductivity, it is required that the SiC preform be of relative density of 20-75 vol %, preferably 30-70 vol %. If the SiC preform is of relarive density of 20 vol % or less, it will be impossible to have the thermal expansion coefficient below 10×10⁻⁶/K. On the other hand, if this volume percentage is larger than 75%, it will be difficult to obtain a high thermal conductivity.

Then, both the internal and external surfaces of the SiC preform obtained in the above-described process are coated with a reaction preventive layer which is in fact the interface layer between the preform and Cu infiltrated into the preform. Here, the reaction preventive layer may be suitably formed by carbon or a carbide of at least one element selected from the group consisting of Cr, Nb, Ta and W.

When the reaction preventive layer is formed by carbon, it is preferable to use an easy method involving a thermal decomposition of methane. Namely, an amount of porous SiC preform is placed in a methane gas flow controlled at a reduced pressure (about 5 kPa), and is heated to a temperature of about 1400° C. In this way, about one hour later it is possible to obtain a thin carbon film having a uniform thickness of about 1 micron.

In fact, the thin carbon film can also be formed by thermally decomposing a resin material such as a phenol resin. For example, a phenol resin is dissolved in an alcohol. Then, after the SiC preform has been sufficiently dipped in the alcohol, the SiC preform is then taken out of the alcohol and dried. Subsequently, the SiC preform is placed in an inert gas atmosphere and is carbonized at a temperature of about 500° C., thereby obtaining a thin carbon film having a high density.

In practice, it is preferable that the thickness of the thin carbon film be controlled at about 10 micron or less. This is because a carbon coating layer usually has a low thermal conductivity, its thickness is preferred to be made as small as possible, provided that it is effective for preventing the aforementioned undesired reaction. Theoretically, a lower limit of the thickness of the carbon coating is allowed to be as small as about 0.01 micron, but since it is difficult to ensure a uniform thickness, an actual thickness is allowed to be about 0.1-3 microns.

On the other hand, the carbide coating may be formed by a common CVD (Chemical Vapor Deposition) method (gas phase reaction). For example, if a vapor of a metal chloride such as chromium (Cr) chloride is caused to react with a hydrocarbon in a gas phase reaction, it is possible to form a carbide thin film.

Subsequently, an amount of Cu melt is press-infiltrated at a high temperature into the SiC preform containing a reaction preventive layer obtained in the above-described process, by virtue of a press-infiltration method generally used in a conventional manufacturing process for manufacturing a metal-based composite material, thereby obtaining a desired composite material.

In this way, if a carbon film is used as a reaction preventive layer and a Cu melt containing for example Cr in an amount of 0.3 atom % or less is infiltrated into a porous preform, it is possible to improve a wetting condition by virtue of a reaction between the carbon and Cr, thereby ensuring a satisfactory combination of Cu with SiC. At this time, although depending upon the thickness, it is possible to form the reaction preventive layer consisting of C and chromium carbide on the aforementioned interface.

In the following, the specification will describe in more detail a first highly thermally conductive composite material and a method for manufacturing the same, by giving several examples according to the present invention.

### Example 1

A portion of SiC powder having an average particle size of 40 microns was mixed with another portion of SiC powder having an average particle size of 2 microns in a mixing ratio of 7:3 in a ball mill. Subsequently, the powder mixture thus treated was molded into a predetermined configuration by means of metal mold, thereby obtaining a molded product. The molded product was then placed in an argon gas atmosphere having one atmospheric pressure and sintered for one hour at a temperature of 2200° C., thereby obtaining a SiC preform having a relative density of about 70%.

Afterwards, the preform was set in an electric furnace and kept (at a temperature of 1400° C. for one hour) in a methane gas flow having a reduced pressure of 5 kPa, thereby carrying out the carbon coating operation and thus forming a reaction preventive layer. Here, the carbon coating was controlled at about 1 micron, in a manner such that both the external and internal surfaces of the preform were uniformly coated with the carbon.

Afterwards, the SiC preform coated with carbon was set in a graphite mould and was subjected to a press-infiltration treatment in which an amount of Cu melted at a temperature of 1200° C. was press-infiltrated into the preform under an uniaxial pressing condition of 4 MPa, thereby obtaining the desired composite material.

The composite material obtained in the above-described process contains about 70 vol % of SiC skeleton having an internally connected structure, with the balance being 30 vol % of Cu serving as matrix, thus forming a structure in which a carbon film having a uniform thickness is located on the interface between the two substances. Then, as a result of analyzing the elements contained in the two phases, it was found that an undesired reaction between SiC and Cu had been effectively prevented by the carbon film. Further, as a result of measuring the thermal conductivity of the obtained composite material using a laser flash method, it was found that the obtained composite material had a high thermal conductivity of at least 200 W/mK. In addition, as a result of measuring the thermal expansion coefficient of the obtained composite material from a room temperature to 500° C., it was found that the composite material had a low thermal expansion coefficient of 6×10⁻⁶/K.

### Comparative Example 1

Although this comparative example is almost the same as the above Example 1, the above-described reaction presentive carbon layer was not formed, while Cu is press-infiltrated into the prepared SiC preform under the same condition as used in Example 1, thereby obtaining a composite material.

The obtained composite material was found to have undergone a remarkable reaction between SiC and Cu, and its thermal conductivity was as low as 100 W/mK or less.

### Example 2

30 parts by weight of SiC powder having an average particle size of 40 microns, 49 parts by weight of Si powder having an average particle size of 10 microns, and 11 parts by weight of carbon powder having an average particle size of 6 microns were mixed together to form a powder mixture in a ball mill. Subsequently, the powder mixture (thus treated) was molded into a predetermined configuration by means of a metal mold, thereby obtaining a molded product. The molded product was then placed in an argon gas atmosphere having one atmospheric pressure and sintered for one hour at a temperature of 1600° C., thereby obtaining SiC preform having a relative density of about 50%.

Then, an amount of phenol resin was dissolved in an ethyl alcohol to form a solution having a phenol resin concentration of 10%. Afterwards, the SiC preform was dipped in the solution. Subsequently, the SiC preform was taken out of the solution and dried sufficiently. Then, the SiC preform was moved into an electric furnace and heated in an argon gas atmosphere for one hour, with a heating temperature being from the room temperature to 1000° C., thereby effecting a predetermined carbonization. The obtained SiC preform was found to have been coated with a carbon film having a thickness of about 3 microns.

Afterwards, the SiC preform coated with carbon was set in a graphite mould and was subjected to a press-infiltration treatment in which an mount of Cu was press-infiltrated into the preform under the same condition as used in the above Example 1, thereby obtaining the desired composite material. However, at this time, the material to be infiltrated into the preform was an amount of Cu in which 0.3 atom % of Cr was dissolved.

The composite material obtained in the above-described process has an internally connected SiC skeleton, with the balance being Cu, and with an interface between the two substances being formed by carbon and an amount of Cr₃C₂.

A second SiC—Cu composite material having a high thermal conductivity, formed according to the present invention, may be manufactured in a process which includes coating a SiC powder material with a reaction preventive layer, mixing the SiC powder with Cu powder to form powder mixture, and press-sintering the powder mixture.

Here, the SiC powder material may be a commercially available SiC raw material powder. However, in order to obtain a high thermal conductivity, it is required to use a SiC powder material having a high purity and an excellent crystallinity.

Then, the entire surface of SiC powder material was coated with a reaction preventive layer. Specifically, the reaction preventive layer may be formed by carbon or a carbide of at least one element selected from the group consisting of Cr, Nb, Ta and W.

Here, if the reaction preventive layer is formed by carbon, there is an easy method involving the thermal decomposition of methane. Namely, the SiC powder material is placed in a methane flow and is heated to a temperature of 1400° C. In this way, after being treated for about one hour, it is possible to obtain a thin carbon coating having a uniform thickness of 1 micron. At this time, it is preferable that the SiC powder material be fluidized.

As another easy method, the carbon film can be obtained by the thermal decomposition of a phenol resin or the like. For example, at first, a phenol resin is dissolved in an alcohol. Then, the SiC powder is mixed into the alcohol and a spray drying is subsequently carried out to dry the powder. Afterwards, the powder so treated is carbonized in an inert gas atmosphere at a temperature of about 500° C., thereby obtaining SiC powder tightly coated with a thin film.

In practice, it is preferable that the thickness of the thin carbon film be controlled at about 10 micron or less. This is because the carbon coating layer usually has a low thermal conductivity, so that its thickness is preferred to be made as small as possible, provided that such thickness is effective for preventing the aforementioned undesired reaction. Theoretically, a lower limit of the thickness of the carbon coating is allowed to be as small as about 0.01 microns, but since a uniform thickness is difficult to obtain, an actually needed thickness is allowed to be about 0.1-3 microns. On the other hand, the carbide coating may be formed by a common CVD (Chemical Vapor Deposition) method (gas phase reaction). For example, if a vapor of a metal chloride such as chromium (Cr) chloride is caused to react with a hydrocarbon in a gas phase reaction, it is possible to form a carbide thin film.

With regard to Cr carbide, as another coating method, it is possible to use a process in which a SiC powder coated with the above carbon film is placed in a high temperature Cr vapor so as to form a chromium carbide. In this way, since it is possible for Cr to produce a sufficiently high vapor pressure within a temperature range from about 1300° C. to about 1500° C., it is possible to form the desired carbide within a short time period.

Then, SiC powder material coated with a reaction preventive layer obtained in the above-described process is mixed with Cu powder, in such a mixing ratio that the SiC powder is 20-75 vol %, with the balance being Cu powder. In fact, such a mixing ratio has been found to be effective for obtaining a low thermal expansion coefficient and a high thermal conductivity. If the SiC powder is mixed in an amount of 20 vol % or less, it will be impossible to obtain a thermal expansion coefficient which is equal to or lower than 10×10⁻⁶/K. On the other hand, if the SiC powder is mixed in an amount of 75 vol % or more, it will be difficult to obtain a high thermal conductivity.

The mixing process may be carried out by using one of various dry or wet type mixing methods which have long been traditionally used in industry.

After the mixed powder obtained in the above-described process has been moved to fill the graphite mold, a press-sintering process is carried out in a vacuum condition or in an inert gas atmosphere, thereby obtaining a desired sintered body.

Here, a temperature for carrying out the sintering process may be 400-1000° C. In fact, if the sintering temperature is high, a necessary pressure for press-sintering is only about several MPa. On the other hand, if the sintering temperature is low, a necessary pressure for press-sintering is needed to be increased.

If a carbon film is used as the above-described reaction preventive layer, and if Cu powder to be used contains 0.3 atom % or less of Cr (solid-dissolved in Cu), a favourable result can be obtained which means that during sintering process, the carbon will have a diffusive reaction with Cr so that a desired carbide may be formed, thereby improving an interface strength and effecting a satisfactory combination between different substances. At this time, although a result will depend upon the thickness of a film, it is possible to form, on the above-described interface, a reaction preventive layer consisting of C and chromium carbide.

In the following, the specification will describe in detail a second highly thermally conductive composite material and a method for manufacturing the same, by giving several examples according to the present invention. However, the present invention should not be limited to any extent by these examples.

### Example 3

A portion of SiC powder having an average particle size of 40 microns was set in an electric furnace and kept (at a temperature of 1400° C. for one hour) in a methane gas flow having a reduced pressure of 5 kPa, thereby effecting the coating with carbon and thus forming a reaction preventive layer. Here, the coating is controlled at about 1 micron, in a manner such that the powder was uniformly coated with the carbon.

Afterwards, the SiC powder coated with carbon was mixed with Cu powder having an average particle size of 30 microns, at a mixing ratio of 60:40 by volume. Here, the mixing was a dry type operation conducted in a ball mill, thereby obtaining a mixed powder. The mixed powder obtained in this manner was set in a graphite mould and was subjected to a press-sintering treatment under an uniaxial pressing condition of 4 MPa at a temperature of 800° C., thereby obtaining, in the form of a sintered body, the desired composite material having a high thermal conductivity.

The composite material obtained in the above-described process contains about 60 vol % of SiC, with the balance 40 vol % being Cu which serves as matrix, thereby forming a structure in which a carbon film having a uniform thickness is located on the interface between the two substances. Upon analyzing the elements contained in the two phases, it was found that an undesired reaction between SiC and Cu had been effectively prevented by the carbon film. Further, upon measuring the thermal conductivity of the obtained composite material using a laser flash method, it was found that the obtained composite material had a high thermal conductivity of 200 W/mK or higher. In addition, upon measuring the thermal expansion of the obtained composite material under conditions from a room temperature to 500° C., it was found that the composite material had a low thermal expansion coefficient of 6×10⁻⁶/K.

### Comparative Example 3

This comparative example is almost the same as the above Example 3, except that the SiC powder used here was not coated with carbon.

The composite material obtained in this comparative example was found to have had a remarkable reaction between SiC and Cu. The measured thermal conductivity was found to be 100 W/mK or lower.

### Example 4

20 g of phenol resin was dissolved in 100 cc of ethyl alcohol. Then, 100 g of SiC powder having an average particle size of 40 microns was added in the ethyl alcohol, thereby forming a slurry. Subsequently, the obtained slurry was subjected to a spray drying treatment, thus obtaining a SiC powder coated with the resin. Afterwards, the same powder was moved into a graphite crucible and heated in an argon gas atmosphere for one hour until the powder arrives at a temperature of 1000° C., thereby carbonizing the phenol resin. In this way, the obtained SiC powder was uniformly coated with a carbon layer having a thickness of about 1 micron.

Subsequently, an alumina crucible containing 1 g of Cr powder, as well as graphite mould filled with the SiC powder coated with carbon, were arranged side by side into a furnace. Then, the powders were heated at a temperature of 1500° C. for 30 minutes. As a result, it was found that the surface layer of SiC powder coated with carbon had been changed to chromium carbide.

Afterwards, 14 g of the powder obtained in the above process, 26 g of Cu powder having an average particle size of 30 microns were mixed sufficiently in a ball mill, thereby obtaining a mixed powder. Then, 2 g of the mixed powder was set in graphite mould fill with an argongas atmosphere having one atmospheric pressure and was subjected to a press-sintering treatment under an uniaxial pressurized condition of 5 MPa, at a temperature of 800° C. for 20 minutes, thereby obtaining, in the form of a sintered body, the desired composite material having a high thermal conductivity.

The composite material obtained in the above-described process has such a structure that it contains SiC phase, with the balance being Cu, and that the interface between the two substances is composed by carbon and Cr₃C₂.

What is claimed is:

1. A highly thermally conductive composite material characterized in that said material contains 20-75 Vol % of SiC, with the balance being Cu, and further contains a reaction preventive layer interposed on the interface between SiC and Cu for preventing a reaction between the two substances.

2. A composite material according to claim 1, wherein said reaction preventive layer is a thin film having a thickness of 0.01-10 microns, consisting of carbon or a carbide of at least one element selected from the group consisting of Cr, Nb, Ta and W.

3. A composite material according to claim 1, wherein said composite material has a thermal expansion coefficient of 4.5-10×10⁻⁶/K and a thermal conductivity of 200 W/mK or higher.

4. A composite material according to claim 1, wherein the SiC forms a porous preform having a skeleton structure, the reaction preventive layer is formed on the surface of the porous preform, the Cu is infiltrated into the preform.

5. A composite material according to claim 1, wherein said composite material is in the form of a sintered body obtained by press-sintering an amount of a mixed powder containing SiC powder material and Cu powder, said SiC powder material being coated with the reaction preventive layer.

6. A highly thermally conductive composite material characterized in that said material contains 20-75 Vol % of SiC, with the balance being Cu, and further contains a reaction preventive layer interposed on the interface between SiC and Cu for preventing a reaction between the two substances; said reaction preventive layer is a thin film having a thickness of 0.01-10 microns, consisting of carbon or a carbide of at least one element selected from the group consisting of Cr, Nb, Ta and W; said composite material has a thermal expansion coefficient of 4.5-10×10⁻⁶/K and a thermal conductivity of 200 W/mK or higher.

7. A composite material according to claim 6, wherein the SiC forms a porous preform having a skeleton structure, the reaction preventive layer is formed on the surface of the porous preform, the Cu is infiltrated into the preform.

8. A composite material according to claim 6, wherein said composite material is in the form of a sintered body obtained by press-sintering an amount of a mixed powder containing SiC powder material and Cu powder, said SiC powder material being coated with the reaction preventive layer.

9. A method of manufacturing a highly thermally conductive composite material, characterized in that both the internal and external surfaces of a porous SiC preform having a skeleton structure are coated with a reaction preventive layer consisting of an element or a compound which will not react with either SiC or Cu, nor will it be substantially solid-dissolved into the two phases, followed by press-infiltrating Cu into the preform.

10. A manufacturing method according to claim 9, wherein said reaction preventive layer is a thin film consisting of carbon or a carbide of at least one element selected from the group consisting of Cr, Nb, Ta and W, said thin film being formed by coating and being controlled within a thickness of 0.01-10 microns.

11. A method of manufacturing a highly thermally conductive composite material, characterized in that after the surface of SiC powder material has been coated with a reaction preventive layer consisting of an element or a compound which will not react with either SiC or Cu, not will it be substantially solid-dissolved into the two phases, the SiC powder material is mixed with Cu powder so as to form a powder mixture which is in turn press-sintered at a temperature of 400-1000° C.

12. A manufacturing method according to claim 11, wherein said mixed powder is formed by mixing 20-75 vol % of SiC powder material coated with a reaction preventive layer, with the balance of Cu powder.

13. A manufacturing method according to claim 11, wherein said reaction preventive layer is a thin film consisting of carbon or a carbide of at least one element selected from the group consisting of Cr, Nb, Ta and W, said thin film being formed by coating and being controlled within a thickness of 0.01-10 microns.
